(19) United States
(12) Patent Application Publication
(10) Pub. No.: US 2004/0109320 A1
(43) Pub. Date: Jun. 10, 2004

(54) Structure of foldable lampshade

(76) Inventor: Yen-Ping Sun, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/309,284

(22) Filed: Dec. 4, 2002

(51) Int. Cl. F21V 11/00

(52) U.S. Cl. 362/352; 362/319; 362/351

(57) ABSTRACT

In the improved structure of foldable lampshade, the lampshade is comprised of a shading member, an upper annular ring and a lower annular ring; and a plurality of supporting posts provided between the upper and lower annular rings for bracing up the shading member. The structure is characterized by: the supporting posts are in the form structurally of individual rods, and the upper and lower annular rings are provided on the peripheries thereof at the positions in corresponding with those of the two ends of every supporting post respectively with recesses and holes; and the two ends of every supporting post are provided respectively with an engaging portion and a hooking portion able to be engaged correspondingly with the a recess and a hole. Thereby, when the supporting posts are mounted between the upper and lower annular rings, the engaging portions and hooking portions can be engaged with recesses and holes on the upper and lower annular rings to make firm connection between the upper and lower annular rings and the supporting posts.

### BACKGROUND OF THE INVENTION

1. Field of the Invention

The present invention is related to an improved structure of foldable lampshade, and especially to a lampshade structure convenient for assembling, wherein by improvement of a rack structure with supporting posts and an upper and a lower annular ring, limitation to the height difference between the upper annular ring and a plurality of connecting rods is largely reduced, this increases applicability of the lampshade on the whole.

2. Description of the Prior Art

As shown in FIG. 1 which shows a schematic view of a foldable lampshade structure that the applicant of the present invention developed before, in which the main body of the lampshade includes on the upper and the lower ends of the shading member 1 an upper annular ring 2 and a lower annular ring 3, and a plurality of supporting posts 4 provided between the upper and lower annular rings 2, 3 and capable of bracing up the shading member 1; the supporting posts 4 brace up the whole lampshade to form a truncated conical shading member 1; an assembling ring 21 is provided at the center of the upper annular ring 2 for assembling of the lampshade with a lamp set, the assembling ring 21 is provided externally thereof with a plurality of connecting rods 22 arranged in a radiation form and connected between the assembling ring 21 and the upper annular ring 2 to get better structural strength.

And wherein the supporting posts 4 are bracing structural members formed by bending of elastic rods, the tops of them are transverse rod sections 42 to be abutted against the upper annular ring 2, both ends of each transverse rod section 42 are bent down and extended to the lower annular ring 3 to be the vertical sections 41 of one of the supporting posts 4; the supporting posts 4 are supported by the transverse rod sections 42 at the connecting areas of the connecting rods 22 with the upper annular ring 2; and the lower ends of the vertical sections 41 are abutted on the lower annular ring 3. Hence, by the elasticity of the vertical sections 41, the shading member 1 can be surely braced up.

And more, the upper and lower annular rings 2, 3 of the lampshade can be designed (taking the lower annular ring 3 with a larger area as an example) to divide the lower annular ring 3 into two half circles 31 which are pivotally connected at pivots 32 and can be folded one over the other. Therefore, when the lampshade is dismantled, the supporting posts 4 can be detached to make collapsing of the upper and lower annular rings 2, 3, the foldable annular rings (in the drawing, referring is made to the lower annular ring 3) can largely reduce the height and the area occupied by the whole lampshade, thereby, material for packing and cost of shipping can be reduced.

In the abovementioned foldable lampshade structure that the applicant of the present invention developed before, assembling of the supporting posts 4 and the upper and lower annular rings 2, 3 is done in the way as below: the lower end of each vertical section 41 of any of the supporting posts 4 is abutted on the lower annular ring 3, and the transverse rod sections 42 of the supporting posts 4 are abutted on the lower sides of the connecting rods 22; while the supporting posts 4 are abutted on the external surface of the upper annular ring 2, thereby, the transverse rod sections 42 of the supporting posts 4 slide along the connecting rods 22 into the connecting areas of the connecting rods 22 with the upper annular ring 2. The height difference between the upper annular ring 2 and the connecting rods 22 after assembling allows positioning of the transverse rod sections 42 of the supporting posts 4; such a structural design surely provides quite convenience for assembling the supporting posts 4with the upper and lower annular rings 2, 3, but it also gives a limitation to the height difference between the connecting rods 22 and the upper annular ring 2, this in turn gives a limitation to the relative heights of the assembling ring 21 and the upper annular ring 2.

### SUMMARY OF THE INVENTION

Therefore, the primary object of the improved structure of foldable lampshade of the present invention is to make the supporting posts thereof in the form structurally of individual rods, and to render the upper and lower annular rings to be provided on the peripheries thereof at the positions in corresponding with those of the two ends of every supporting post respectively with recesses and holes; and the two ends of every supporting post are provided respectively with an engaging portion and a hooking portion able to be engaged correspondingly with a recess and a hole. In this way, when the supporting posts are mounted between the upper and lower annular rings, the engaging portions and hooking portions can be engaged with recesses and holes on the upper and lower annular rings to make firm connection between the upper and lower annular rings and the supporting posts.

Another object of the improved structure of foldable lampshade of the present invention is to render the upper and lower annular rings to be provided on the peripheries thereof at the positions in corresponding with those of the two ends of every supporting post respectively with recesses and holes to be inserted and engaged by the engaging portions and hooking portions provided on the two ends of every supporting post without interference with the connecting rods on the upper annular ring. Thereby, the height difference between the connecting rods and the upper annular ring will have no limitation, and correspondingly, the relative heights of the assembling ring and the upper annular ring will have no limitation, hence the applicability of the lampshade on the whole is increased.

The present invention will be apparent after reading the detailed description of the preferred embodiment thereof in reference to the accompanying drawings.

### BRIEF DESCRIPTION OF THE DRAWINGS

FIG. 1 is a perspective schematic view showing a foldable lampshade structure that the applicant of the present invention developed before;

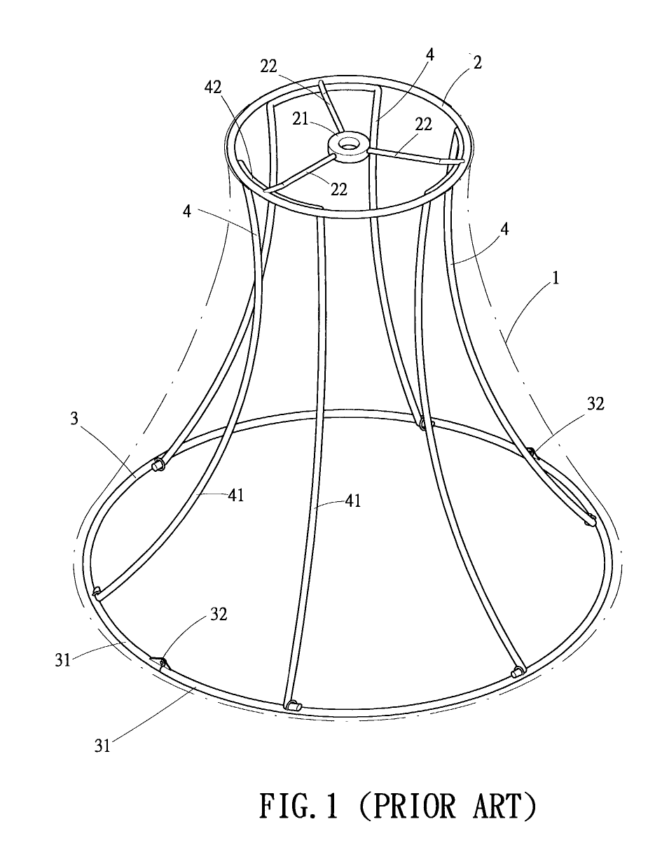

FIG. 2 is a perspective view showing the appearance of the whole lampshade structure of the present invention;

FIG. 3 is an analytic perspective view showing the structure of the supporting posts and the upper and lower annular rings of the present invention;

FIG. 4 is an exploded perspective view showing the state of assembling of the supporting posts and the upper and lower annular rings of the present invention;

FIG. 5 is a schematic view showing a hooking portion of a supporting post is inserted into a hole of the lower annular ring;

FIG. 6 is a schematic view showing a hooking portion of a supporting post is inserted into a hole of the lower annular ring and an engaging portion of a supporting post is engaged with a recess of the upper annular ring;

FIG. 7 is a sectional schematic view showing a hooking portion of a supporting post is inserted into a hole of the lower annular ring and an engaging portion of a supporting post is engaged with a recess of the upper annular ring.

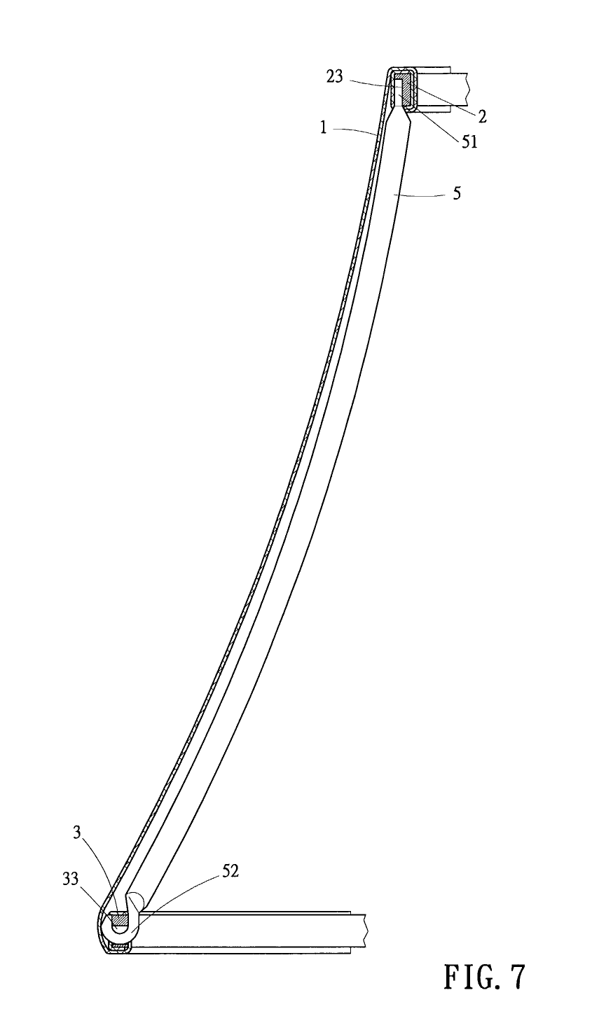

### DETAILED DESCRIPTION OF THE PREFERRED EMBODIMENT

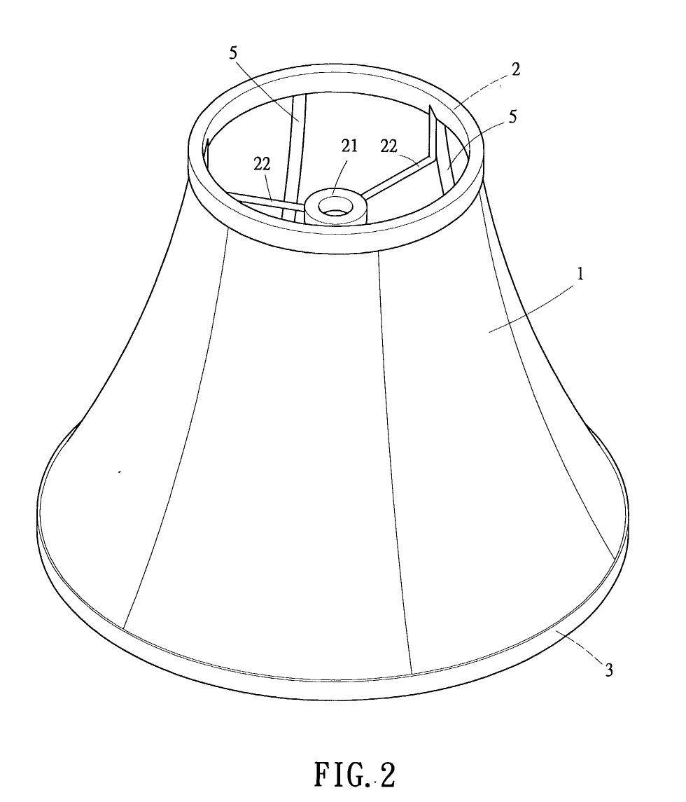

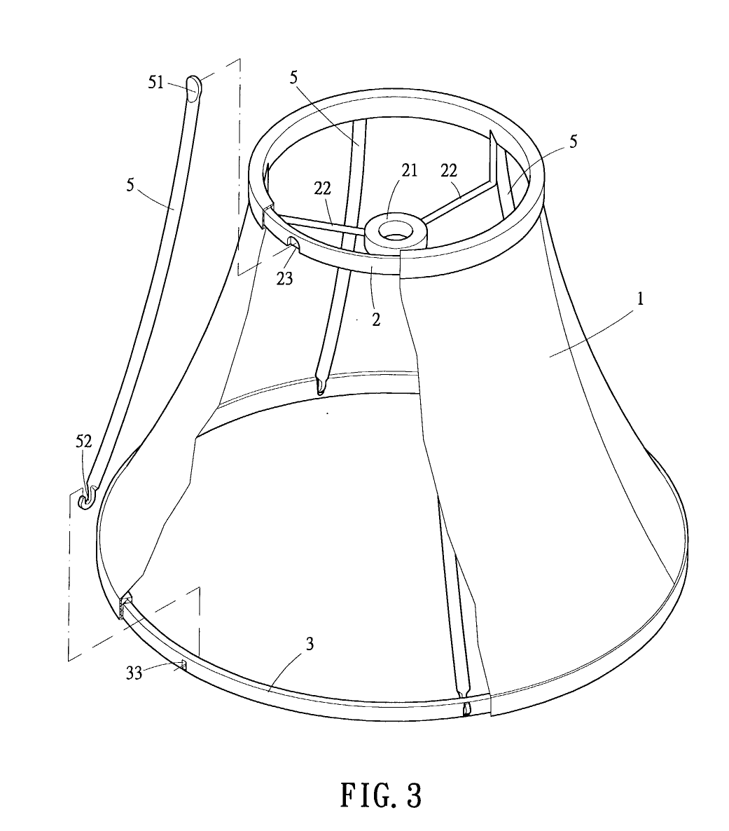

On the improved structure of foldable lampshade of the present invention as shown in FIGS. 2 and 3, the main body of the lampshade likely includes on the upper and the lower ends of a shading member 1 an upper annular ring 2 and a lower annular ring 3, and a plurality of supporting posts 5 provided between the upper and lower annular rings 2, 3 and capable of bracing up the shading member 1; the supporting posts 5 brace up the whole lampshade to form the shading member 1 a truncated conical surface; an assembling ring 21 is provided at the center of the upper annular ring 2 for assembling of the lampshade with a lamp set, the assembling ring 21 is provided externally thereof with a plurality of connecting rods 22 arranged in a radiation form and connected between the assembling ring 21 and the upper annular ring 2 to get better structural strength.

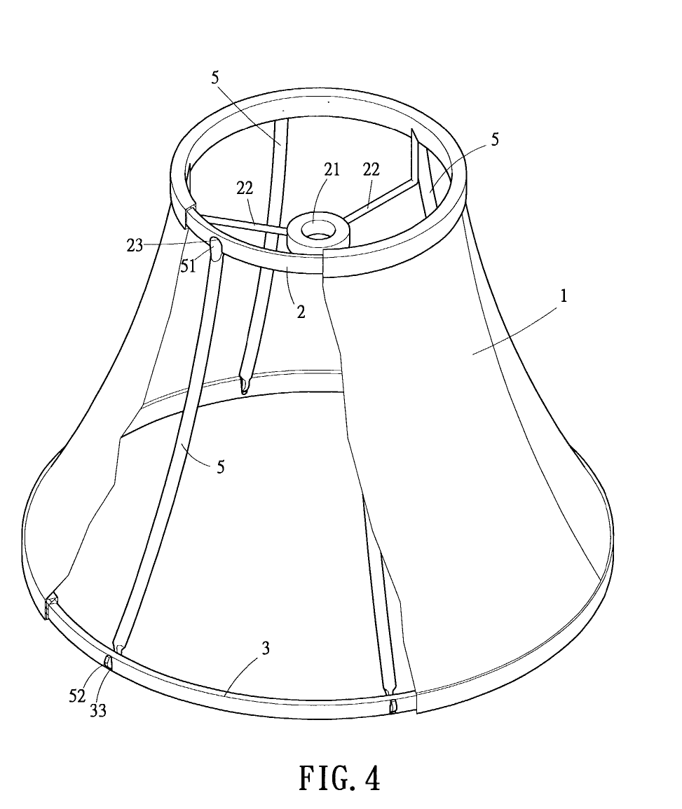

Referring simultaneously to FIGS. 3 and 4, wherein the supporting posts 5 are in the form structurally of individual rods, and the upper and lower annular rings 2, 3 are provided on the peripheries thereof at the positions in corresponding with those of the two ends of every supporting post respectively with recesses 23 and holes 33; and the two ends of every supporting post 5 are provided respectively with an engaging portion 51 and a hooking portion 52 able to be engaged correspondingly with a recess 23 and a hole 33. In this way, when the supporting posts 5 are mounted between the upper and lower annular rings 2, 3, the engaging portions 51 and hooking portions 52 can be engaged with recesses 23 and holes 33 on the upper and lower annular rings 2, 3 to make firm connection between the upper and lower annular rings 2, 3 and the supporting posts 5. And the supporting posts 5 with elasticity can surely brace up the shading member 1.

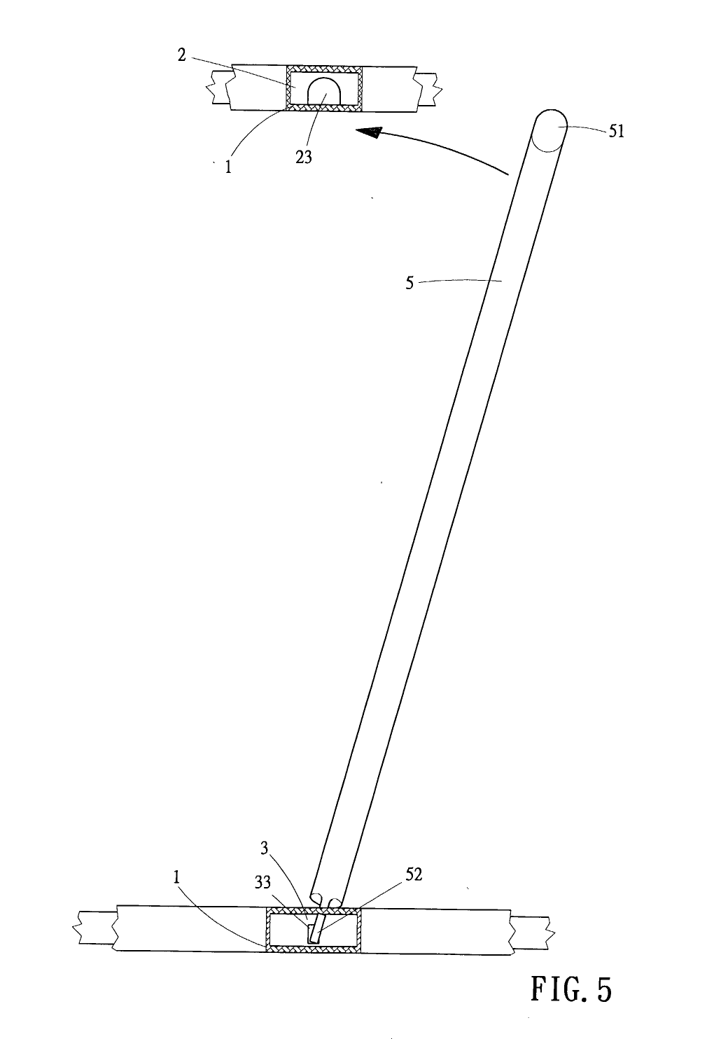

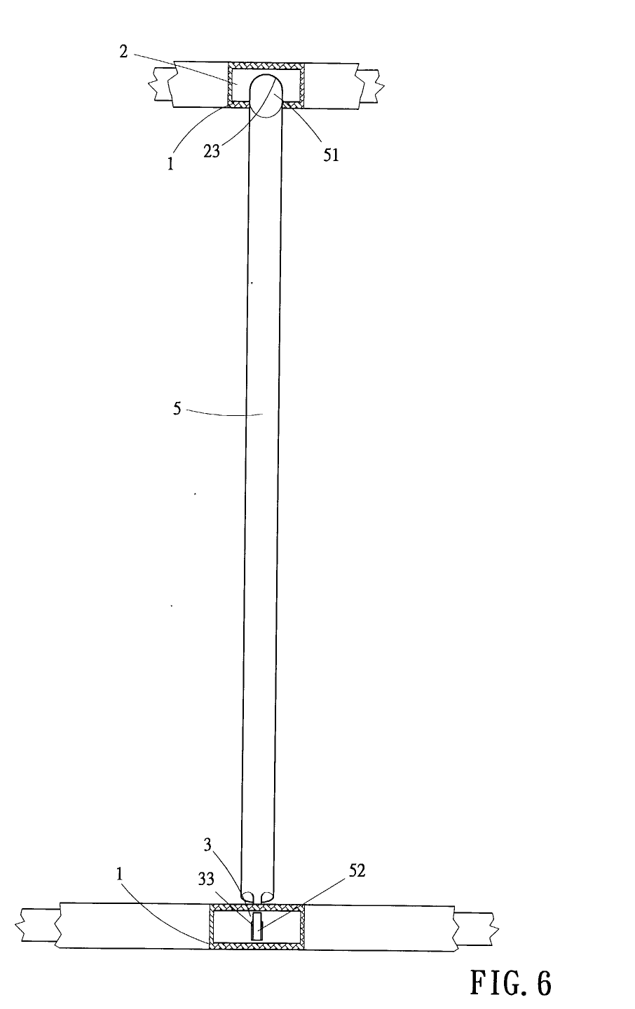

Therefore, when in packing, the supporting posts and the upper and lower annular rings of the lampshade of the present invention are not assembled to thereby largely reduce the height of and the area occupied by the whole lampshade; and also the packing material and cost of shipping can be reduced. When the whole lampshade is to be used and has to be assembled, as shown in FIG. 5, the hooking portions 52 on the lower ends of the supporting posts 5 are inserted into the holes 33 of the lower annular ring 3 in the first place, then the upper ends of the supporting posts 5 are moved to get close to the periphery of the upper annular ring 2, and the engaging portions 51 on the upper ends of the supporting posts 5 are moved respectively toward their corresponding recesses 23 of the upper annular ring 2; as shown in FIG. 6, each of the engaging portions 51 is surely engaged in its corresponding recess 23 to make the structural state of firm connection between the upper and lower annular rings 2, 3 and the supporting posts 5.

Therefore, assembling of the whole lampshade will not interfere with the connecting rods 22 of the upper annular ring 2, and the height difference between the connecting rods and the upper annular ring will have no limitation, and correspondingly, the relative heights of the assembling ring and the upper annular ring will have no limitation, hence the applicability of the lampshade on the whole is increased. The upper and lower annular rings of the lampshade of the present invention surely can be designed as couples of half circles able to be pivotally connected to form the upper and lower annular rings, there are a plurality of pivots provided between the half circles for collapsing by folding the latter, thereby the annular rings can further be collapsed to reduce the areas they occupy.

In the improved structure of foldable lampshade of the present invention, the supporting posts thereof are designed to be in the form structurally of individual rods, the engaging portions and hooking portions of the supporting posts can be engaged with recesses and holes on the upper and lower annular rings to make firm connection between the upper and lower annular rings and the supporting posts without interfering with the connecting rods of the upper annular ring; and the height difference between the connecting rods and the upper annular ring will have no limitation, and correspondingly, the relative heights of the assembling ring and the upper annular ring will have no limitation, hence the applicability of the lampshade on the whole is increased.

Having thus described a better structure of foldable lampshade of the present invention, what we claim as new and desire to be secured by Letters Patent of the United States are:

1. An improved structure of foldable lampshade, said lampshade is comprised of a shading member, an upper annular ring and a lower annular ring; and a plurality of supporting posts are provided between said upper and lower annular rings for bracing up said shading member; said structure is characterized by:
said supporting posts are in the form structurally of individual rods, and said upper and lower annular rings are provided on the peripheries thereof at the positions in corresponding with those of the two ends of every of said supporting posts respectively with recesses and holes; and the two ends of every of said supporting posts are provided respectively with an engaging portion and a hooking portion adapted to engaging with corresponding one of said recesses and holes; in this way, said engaging portions and hooking portions are adapted to engaging with corresponding ones of said recesses and holes on said upper and lower annular rings to make firm connection between said upper and lower annular rings and said supporting posts.

2. An improved structure of foldable lampshade as in claim 1, wherein, said lower annular ring is composed of two half circles which are pivotally connected at a plurality of pivots.

3. An improved structure of foldable lampshade as in claim 1, wherein, said upper annular ring is composed of two half circles which are pivotally connected at a plurality of pivots.

4. An improved structure of foldable lampshade as in claim 2, wherein, said upper annular ring is composed of two half circles which are pivotally connected at a plurality of pivots.

5. An improved structure of foldable lampshade as in claim 1, wherein, an assembling ring is provided at the center of said upper annular ring for assembling of said lampshade with a lamp set, said assembling ring is provided externally thereof with a plurality of connecting rods arranged in a radiation form and connected between said assembling ring and said upper annular ring to get better structural strength.
